(19) United States
(12) Patent Application Publication
(10) Pub. No.: US 2026/0268390 A1
(43) Pub. Date: Sep. 10, 2026

(54) INFORMATION PROCESSING METHOD AND APPARATUS, DEVICE, MEDIUM, AND PROGRAM PRODUCT

(71) Applicant: TENCENT TECHNOLOGY (SHENZHEN) COMPANY LIMITED, Shenzhen, (CN)

(72) Inventors: Xiaowen LIANG, Shenzhen (CN); Yonghong WANG, Shenzhen (CN)

(73) Assignee: TENCENT TECHNOLOGY (SHENZHEN) COMPANY LIMITED, Shenzhen, (CN)

(21) Appl. No.: 19/659,005

(22) Filed: Apr. 27, 2026

Related U.S. Application Data
(63) Continuation of application No. PCT/CN2025/070632, filed on Jan. 6, 2025.

(30) Foreign Application Priority Data
Jan. 30, 2024 (CN) 202410132841.1

(51) Int. Cl. G06Q 30/0601; G06F 3/04817; G06F 3/0483; G06F 40/166; G06T 13/80

(52) U.S. Cl. CPC G06Q 30/0641; G06F 3/04817; G06F 3/0483; G06F 40/166; G06T 13/80

(57) ABSTRACT

An information processing method includes displaying a reading interface of a text reading platform, the reading interface being configured for a reader to read an online or offline reading text; and presenting text of target product content in the reading interface based on receiving a page-turning event, the text having a literary style feature associated with the reading text.

### RELATED APPLICATION

This application is a continuation application of International Application No. PCT/CN2025/070632 filed on Jan. 6, 2025, which claims priority to Chinese Patent Application No. 202410132841.1, filed with the China National Intellectual Property Administration on Jan. 30, 2024, the disclosures of each being incorporated by reference herein in their entireties.

### FIELD

The disclosure relates to the field of computer technologies, and in particular, to information processing.

### BACKGROUND

With the development of computer technologies, the application of information processing has become increasingly widespread. For example, through information processing, advertisements may be presented in a reading interface of a reading platform.

In the related art, when product content needs to be presented, product content provided by a provider is directly presented in the reading interface of the reading platform. The product content provided by the provider has low relevance to the reading text in the reading platform. Directly presenting the product content in the reading interface tends to increase the visual abruptness of a user, reduce the interaction rate between the user and the product content, and result in a low conversion rate of the product content, leading to poor information processing effects.

### SUMMARY

Some embodiments provide an information processing method, an information processing apparatus, and a computer device.

One or more embodiments provide an information processing method, performed by a computer device, including: displaying a reading interface of a text reading platform, the reading interface being configured for a reader to read an online or offline reading text; and presenting text of target product content in the reading interface based on receiving a page-turning event, the text having a literary style feature associated with the reading text.

One more embodiments provide an information processing apparatus including: at least one memory configured to store program code; and at least one processor configured to read the program code and operate as instructed by the program code, the program code comprising: display code configured to cause at least one of the at least one processor to display a reading interface of a text reading platform, the reading interface being configured for a reader to read an online or offline reading text; and presentation code configured to cause at least one of the at least one processor to present text of target product content in the reading interface based on receiving a page-turning event, the text having a literary style feature associated with the reading text.

One or more embodiments provide a non-transitory computer-readable storage medium, storing computer code which, when executed by at least one processor, causes the at least one processor to at least: display a reading interface of a text reading platform, the reading interface being configured for a reader to read an online or offline reading text; and present text of target product content in the reading interface based on receiving a page-turning event, the text having a literary style feature associated with the reading text.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a schematic diagram of an implementation environment of an information processing method according to one or more embodiments.

FIG. 2 is a flowchart of an information processing method according to one or more embodiments.

FIG. 3 is a schematic diagram of a reading interface according to one or more embodiments.

FIG. 4 is a schematic diagram of a reading interface according to one or more embodiments.

FIG. 5 is a flowchart of an information processing method according to one or more embodiments.

FIG. 6 is a schematic diagram of a reading interface according to one or more embodiments.

FIG. 7 is a flowchart of a method for generating text by a natural language model based on a source material of a target product content and text feature information of a reading text according to one or more embodiments.

FIG. 8 is a schematic diagram of an information processing apparatus according to one or more embodiments.

FIG. 9 is a schematic structural diagram of a computer device according to one or more embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

Some terms involved in this application are explained below.

Outer Advertising Form: a presentation mode and form of an advertisement, belonging to a style presented by the advertisement during "exposure" in an advertising chain. In similar services, the outer advertising form is constructed by an advertiser through self-rendering, or filled into an advertising slot after being rendered according to a template style by an advertising intermediary platform through a cooperatively embedded Software Development Kit (SDK). This application may be implemented based on an SDK rendering form (for example, designed by an advertising intermediary platform, rendered by SDK, and adapted to an advertising slot), aiming to make an outer form more visually attractive, interactive, and better integrated with a scene. In such a mode with higher advertising effects and lower implementation/investment costs for developers, advertisers are attracted to migrate from self-rendering to SDK rendering in cooperation with an advertising platform.

Native Advertisement: a native advertisement is an advertising form whose appearance, performance, and content are similar to other content on a platform where it is located, so as to blend in with the surrounding environment. The purpose of a native advertisement is to provide user experience similar to other content on the platform, thereby improving the attractiveness of the advertisement and user interaction. Native advertisements may appear on various media platforms, such as social media, news websites, and applications, and forms of the native advertisements include images and texts, videos, audios, and the like.

Nativization: nativization refers to a similarity degree in vision and content between an advertisement and other content on a platform where it is located, so that a user does not feel that the advertisement is abrupt or incongruous when browsing or using the platform. The implementation of nativization helps improve user acceptance and interactivity of the advertisement, thereby enhancing advertising effects. In novel reading media, nativization is manifested as the integration of the advertisement with novel contents, such as the advertising content echoing novel plots, or the advertising form being consistent with a novel literary style, and the like.

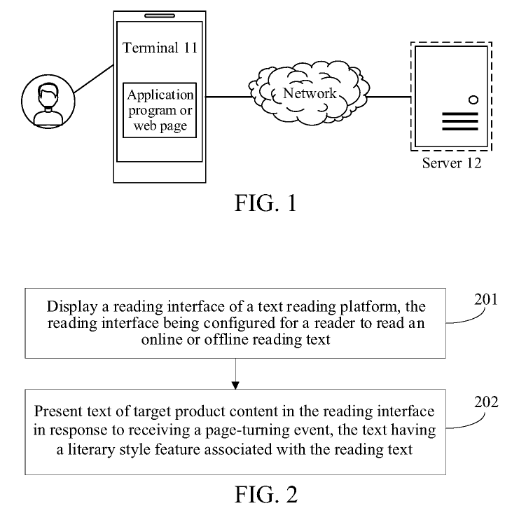

FIG. 1 shows a schematic diagram of an implementation environment of an information processing method according to one or more embodiments. The implementation environment may include a terminal 11 and a server 12.

The terminal 11 has an application program or a web page corresponding to a text reading platform installed thereon. The text reading platform may be any platform that supports reading texts, and the application program or the web page corresponding to the text reading platform is a presentation form of the text reading platform. In one or more embodiments, the application program or the web page installed on the terminal 11 may display a reading interface of the text reading platform, for a reader to select a reading text in the reading interface for reading. The text reading platform may insert some product content into the reading text read by the reader. When product content needs to be inserted, the terminal 11 may present, in the reading interface, text of the product content to be inserted. The text has strong literary style relevance to the reading text, which helps reduce visual abruptness of the reader and improve receptiveness of the product content.

The server 12 is configured to provide backend services for the text reading platform. In a possible implementation, the server 12 undertakes main computing work of the text reading platform, and the terminal 11 undertakes secondary computing work of the text reading platform; or, the server 12 undertakes the secondary computing work of the text reading platform, and the terminal 11 undertakes the main computing work of the text reading platform; or, a distributed computing architecture is adopted between the server 12 and the terminal 11 to perform collaborative computing of the text reading platform.

In a possible implementation, the terminal 11 is any electronic product, such as a Personal Computer (PC), a mobile phone, a smartphone, a Personal Digital Assistant (PDA), a wearable device, a handheld portable game device, a Pocket PC (PPC), a tablet computer, a smart vehicle machine, a smart television, a smart speaker, or an on board terminal that may conduct human-computer interaction with an interaction object by using one or more of modes such as a keyboard, a touch pad, a touch screen, a remote controller, a voice interaction or a handwriting device. The server 12 may be one server, a server cluster including multiple servers, or a cloud computing service center. The terminal 11 and the server 12 establish a communication connection through a wired or wireless network.

A person skilled in the art may understand that the terminal 11 and the server 12 described above are merely exemplary and that other existing or hereafter possible terminals or servers (if being suitable for use in this application) are also within the protection scope of this application and are incorporated herein by reference.

One or more embodiments provides an information processing method, which may be applied to the implementation environment shown in FIG. 1 above. The method is performed by a computer device. Exemplarily, the computer device may be a terminal. The embodiments of this application are described by taking the method being performed by a terminal as an example. For example, the method may be performed by a terminal or an application program corresponding to a text reading platform installed on the terminal. As shown in FIG. 2, the information processing method provided in one or more embodiments may include the following operation 201 and operation 202.

Operation 201: Display a reading interface of a text reading platform, the reading interface being configured for a reader to read an online or offline reading text.

The reading interface refers to a front-end presentation interface of the text reading platform. The text reading platform may be any platform that supports reading texts. In some embodiments, the text reading platform may be a platform maintained by a client, a platform maintained by a server, or a platform jointly maintained by the client and the server.

Exemplarily, the terminal displays the reading interface of the text reading platform based on an entry operation of an application program or a web page corresponding to the text reading platform. After the reading interface is displayed, identification information (such as covers and names) of candidate reading texts may be presented in the reading interface. The reading text is presented in the reading interface based on a selection operation of a reader on the identification information of certain reading text, for the reader to read the reading text. The reading text may be an online reading text or an offline reading text, which is not limited herein. The offline reading text refers to a reading text stored locally in the terminal and readable without connecting to a network. In some embodiments, the reading text may also be referred to as a novel.

Exemplarily, a mode in which the reader reads the reading text is that the reader reads the reading text based on sequentially switched reading text pages. Exemplarily, the reading text pages may be switched left and right, or may be switched up and down. In a case that the reader reads the reading text based on the sequentially switched reading text pages, a mode of presenting the reading text in the reading interface is: presenting a first reading text page corresponding to the reading text in the reading interface; and starting from a next reading text page, presenting a next reading text page corresponding to the reading text in the reading interface in response to a switching operation on a previous reading text page, until the entire reading text is completely presented. Different reading text pages present different content in the reading text, and content presented on a next reading text page is continuous with content presented on a previous reading text page.

A switching operation on the reading text page may refer to a sliding operation on the reading text page, or may refer to a triggering operation on a switching control in the reading text page, or may refer to a click operation on the reading text page, which is not limited herein.

Operation 202: Present text of target product content in the reading interface in response to receiving a page-turning event, the text having a literary style feature associated with the reading text.

If the reader triggers a page-turning event during reading of the reading text, the terminal acquires the page-turning event, and presents the text of the target product content in the reading interface in response to the page-turning event.

Exemplarily, the page-turning event is configured for switching a target reading text page displayed in the reading interface. The target reading text page refers to a page after which the text of the advertising content needs to be presented. Which reading text pages in the reading text are the target reading text pages may be set empirically or flexibly adjusted according to application scenarios, which is not limited herein.

In an exemplary embodiment, the target reading text page may refer to a reading text page that has not been updated within a reference duration. The reference duration is set empirically, for example, the reference duration is 1 minute.

In an exemplary embodiment, the target reading text page may refer to a reading text page whose corresponding reading progress satisfies a progress condition. The reading progress corresponding to the reading text page is configured for measuring a read condition of the reading text by the reader after the reading text page is read. A representation mode of the reading progress corresponding to the reading text page may be set empirically or flexibly adjusted according to application scenarios, which is not limited herein. Exemplarily, the reading progress corresponding to the reading text page may be represented by a quantity of reading text pages that have been switched after the reading text page is switched. Exemplarily, the reading progress corresponding to the reading text page may also be represented by a ratio of a number of words of content that has been read in the reading text after content in the reading text page is read to a total number of words of the reading text.

That the reading progress corresponding to the reading text page satisfies the progress condition may be set empirically or flexibly adjusted according to application scenarios, which is not limited herein. Exemplarily, a specific situation where the reading progress satisfies the progress condition is related to a representation mode of the reading progress. Next, a specific situation where the reading progress corresponding to the reading text page satisfies the progress condition is exemplarily described with reference to the representation mode of the reading progress corresponding to the reading text page.

Exemplarily, for a case where the reading progress corresponding to the reading text page is represented by the quantity of reading text pages that have been switched after the reading text page is switched, that the reading progress corresponding to the reading text page satisfies the progress condition may refer to that the quantity of reading text pages that have been switched after the reading text page is switched is an integer multiple of a reference quantity. The reference quantity may be set empirically or flexibly adjusted according to a type of the reading text, which is not limited herein. For example, the reference quantity may be 10, or may be 15, or the like. In such a case, whether the reading progress corresponding to the reading text page satisfies the progress condition may be determined conveniently and quickly by determining whether the quantity of reading text pages that have been switched after the reading text page is switched is an integer multiple of the reference quantity, thereby improving determination efficiency. In addition, such a case may ensure that the text is presented once every reference quantity of reading text pages, so that the text is presented at a fixed frequency (adload), thereby improving acceptance of the text by the reader, further improving an interaction rate between the reader and the product content corresponding to the text, and improving the conversion rate of the product content.

Exemplarily, for the case where the reading progress corresponding to the reading text page is represented by the quantity of reading text pages that have been switched after the reading text page is switched, that the reading progress corresponding to the reading text page satisfies the progress condition may also refer to that the quantity of reading text pages that have been switched after the reading text page is switched is any quantity among candidate quantities. Candidate quantities refer to preset quantities of advertising text that needs to be presented. The candidate quantities may be set empirically or flexibly adjusted according to chapters of the reading text and the like.

Exemplarily, for a case where the reading progress corresponding to the reading text page is represented by the ratio of the number of words of the content that has been read in the reading text after content in the reading text page is read to the total number of words of the reading text, that the reading progress corresponding to the reading text page satisfies the progress condition may refer to that the ratio of the number of words of the content that has been read in the reading text after the content in the reading text page is read to the total number of words of the reading text is any ratio among candidate ratios. Candidate ratios refer to preset ratios of advertising text that needs to be presented. The candidate ratios may be set empirically or flexibly adjusted according to chapters of the reading text and the like.

By properly setting the progress condition, the text may be presented at an end of a complete content paragraph or a complete chapter in the reading text, so as to reduce an abruptness feeling caused by presentation of the text.

Regardless of which of the above cases the target reading text page belongs to, after receiving the page-turning event for switching the target reading text page, the text of the target product content is presented in the reading interface. The target product content refers to product content inserted by the text reading platform for the reading text. The target product content is product content provided by an advertiser to be presented in the reading text of the text reading platform. The target product content may be flexibly set by the text reading platform according to a type of the reading text, the reading progress and the like, or may be flexibly adjusted according to advertising presentation requirements, which is not limited herein.

The reading text is a text written by an author, and the target product content is content provided by an advertiser. The reading text and the target product content are independent of each other. That is, the target product content is not product content embedded into the reading text by the author, but product content inserted and presented by the text reading platform during reading of the reading text according to requirements of the advertiser. Such product content has relatively high flexibility and may be flexibly changed according to requirements.

When the target product content needs to be inserted, in one or more embodiments, the text of the target product content is presented in the reading interface, and the text is configured for introducing the target product content, that is, the reader may learn about the target product content by reading the text. The text has a literary style feature associated with the reading text. Compared with directly presenting the product content, presenting the text having a literary style associated with the reading text helps reduce the visual abruptness of the reader, improve the acceptance of the text by the reader, and increase the interaction rate between the reader and the product content corresponding to the text, thereby improving the conversion rate of the product content and enhancing the information processing effect.

The literary style feature of the text is a feature configured for embodying a literary style of the text. The literary style refers to a style unique to literature. For example, the literary style may include a dialog style, a scene description style, a language style, a sentence pattern style, and the like. The literary style feature of the text may include a feature of a dialog character in the text, a feature of a dialog tone in the text, a feature of a dialog sentence structure in the text, a feature of a scene described in the text, a language style type of the text, a sentence pattern type of the text, and the like. That the text has the literary style feature associated with the reading text means that the literary style feature of the text is determined by considering the reading text, so that the text matches the reading text in literary style, making the text look like a part of the reading text in literary style, and improving relevance between the text and the reading text.

In an exemplary embodiment, that the text has the literary style feature associated with the reading text may mean that the text has a literary style feature associated with the entire reading text, so that the text matches the entire reading text in literary style.

In an exemplary embodiment, that the text has the literary style feature associated with the reading text may also mean that the text has a literary style feature associated with content currently presented in the reading text, so that the text matches the content currently presented in the reading text in literary style.

Certainly, in some embodiments, that the text has the literary style feature associated with the reading text may also mean that the text has a literary style feature associated with the entire reading text, and the text has a literary style feature associated with content currently presented in the reading text, so that the text not only matches the entire reading text in literary style but also matches the content currently presented in the reading text in literary style, thereby fully improving relevance between the text and the reading text from both the overall aspect and the aspect of the content currently presented.

Exemplarily, the content currently presented in the reading text involved above is determined based on a target reading text corresponding to the page-turning event, and a relationship between the content currently presented and content of the target reading text may be flexibly set according to requirements. Exemplarily, the content currently presented includes content of a last sentence in the target reading text page, content of a last paragraph in the target reading text page, entire content in the target reading text page, content of a chapter corresponding to the target reading text page, or entire content from a first sentence in the reading text to a last sentence in the target reading text page. The content currently presented in the reading text may reflect a real-time reading progress of the reader. In a case that the text has the literary style feature associated with the content currently presented in the reading text, relevance between the text and the real-time reading progress of the reader may be improved, the acceptance of the text by the reader is further improved, and the interaction rate between the reader and the product content corresponding to the text is increased, thereby improving the conversion rate of the product content and enhancing the information processing effect.

Exemplarily, different reading texts have different literary styles. Since the text of the target product content has the literary style feature associated with the reading text read by the reader, and different reading texts have different literary styles, the target product content corresponds to different texts for different reading texts, and the different texts have different literary style features. That is, for the same product content, the texts of the same product content presented in different reading texts have different literary style features, and the text has relatively high presentation flexibility, thereby helping improve the presentation effect of the text.

A specific situation where the text has the literary style feature associated with the reading text may be set empirically or flexibly adjusted according to requirements, which is not limited herein. Next, situations where the text has the literary style feature associated with the reading text will be exemplarily described.

In an exemplary embodiment, that the text has the literary style feature associated with the reading text may include at least one of the following case 1 to case 5:

Case 1: the text includes a first text in a dialog form, and a character in a dialog in the first text is associated with a character involved in the content currently presented in the reading text.

The embodiments of this application are described by taking an example where the content currently presented in the reading text involves at least one character. The character involved in the content currently presented in the reading text refers to a character whose name or nickname appears in the content currently presented in the reading text.

That the character in the first text is associated with the character involved in the content currently presented in the reading text may mean that the character in the first text is any character involved in the content currently presented in the reading text, or may mean that the character in the first text is a character having an association relationship with any character involved in the content currently presented in the reading text. For example, the association relationship may refer to a kinship relationship, a hostile relationship, a friend relationship, and the like.

In such case 1, by constructing the text using a dialog of a character associated with the character involved in the content currently presented in the reading text, relevance between the text and the content currently presented in the reading text may be improved from an aspect of the dialog character, visual abruptness caused by presenting the text to the reader is reduced, the acceptance of the text by the reader is improved, and the interaction rate between the reader and the product content corresponding to the text is increased, thereby improving the conversion rate of the product content and enhancing the information processing effect.

Exemplarily, in such case 1, that the text has the literary style feature associated with the reading text may further include that a dialog tone of the character in the dialog in the first text matches a personality of the character described in the reading text.

The dialog tone refers to a tone adopted by a character when speaking, and the dialog tone may be embodied through some modal particles. Taking an example where the character in the dialog in the first text is any character involved in the reading text, the reading text describes a personality of the character, for example, the personality of the character is gentle, vitriolic or the like. That the dialog tone of the character in the dialog in the first text matches the personality of the character described in the reading text means that the dialog tone of the character in the dialog in the first text is a tone commonly used by a character having the personality of the character described in the reading text in dialog. For example, if the personality of the character in the dialog in the first text is gentle, the tone of the character in the dialog in the first text is a gentle tone; and if the personality of the character in the dialog in the first text is vitriolic, the tone of the character in the dialog in the first text is a vitriolic tone.

By constructing the text using a dialog of a character in the reading text having a dialog tone matching the personality of the character, relevance between the text and the content currently presented in the reading text may be improved from an aspect of the dialog tone, visual abruptness caused by presenting the text to the reader is reduced, the acceptance of the text by the reader is improved, and the interaction rate between the reader and the product content corresponding to the text is increased, thereby improving the conversion rate of the product content.

Case 2: the text includes a first text in a dialog form, and a dialog sentence structure of the first text matches a dialog sentence structure in the content currently presented in the reading text.

The dialog sentence structure is configured for indicating a sequence of a character description and dialog content. The character description is configured for describing a name of a character and expressions, actions, and the like of the character during dialog. Exemplarily, the dialog sentence structure may refer to that the character description is placed before the dialog content, referring to a sentence structure of Dialog 1 below; or may refer to that the dialog content is placed before the character description, referring to a sentence structure of Dialog 2 below; or may refer to that the character description is placed in the middle, with the dialog content placed before and after the character description, referring to a sentence structure of Dialog 3 below.

Dialog 1: Character A said happily, "I won a prize!".

Dialog 2: "I won a prize!" Character A said happily.

Dialog 3: "Haha." Character A said happily, "I won a prize!".

That the dialog sentence structure of the first text matches the dialog sentence structure in the content currently presented in the reading text may mean that the dialog sentence structure of the first text is consistent with a dialog sentence structure of any dialog in the content currently presented in the reading text, or may mean that the dialog sentence structure of the first text is a dialog sentence structure with the highest usage frequency among all dialogs in the content currently presented in the reading text, and the like.

In such case 2, by constructing the text using a dialog sentence structure matching the dialog sentence structure in the content currently presented in the reading text, relevance between the text and the content currently presented in the reading text may be improved from an aspect of the dialog sentence structure, visual abruptness caused by presenting the text to the reader is reduced, the acceptance of the text by the reader is improved, and the interaction rate between the reader and the product content corresponding to the text is increased, thereby improving the conversion rate of the product content and enhancing the information processing effect.

Case 3: the text includes a second text in a scene description form, and a scene described in the second text is associated with a scene involved in the content currently presented in the reading text.

The scene description form is a narrative form, i.e., a non-dialog form.

In an exemplary embodiment, that the scene described in the second text is associated with the scene involved in the content currently presented in the reading text may mean that the scene described in the second text is a further detailedly described scene of the scene involved in the content currently presented in the reading text; or may mean that a type of the scene described in the second text is the same as a type of the scene involved in the content currently presented in the reading text. For example, the type of the scene may refer to a war scene, a daily life scene, and the like. In some embodiments, the scene may also be referred to as a plot, a storyline, and the like.

In such case 3, by constructing the text by describing a scene associated with the scene involved in the content currently presented in the reading text, relevance between the text and the content currently presented in the reading text may be improved from an aspect of the scene, visual abruptness caused by presenting the text to the reader is reduced, the acceptance of the text by the reader is improved, and the interaction rate between the reader and the product content corresponding to the text is increased, thereby improving the conversion rate of the product content and enhancing the information processing effect.

Case 4: a language style type of the text is consistent with a language style type of the reading text.

A language style refers to a writing style of content of a text. Exemplarily, the language style type may include a humorous and witty language style, a domineering language style, an aloof language style, a fresh and natural language style, and the like.

In such case 4, by constructing the text using a language style type consistent with the language style type of the reading text, relevance between the text and the content currently presented in the reading text may be improved from an aspect of the language style, visual abruptness caused by presenting the text to the reader is reduced, the acceptance of the text by the reader is improved, and the interaction rate between the reader and the product content corresponding to the text is increased, thereby improving the conversion rate of the product content and enhancing the information processing effect.

Case 5: a sentence pattern of the text is the same as a sentence pattern of the reading text.

The sentence pattern refers to a form of sentences in a text. For example, the sentence pattern may refer to a balanced sentence pattern, such as antithetical sentences and parallel sentences. For another example, the sentence pattern may refer to a loose sentence pattern, and a loose sentence refers to a sentence with uneven and varying lengths. For another example, the sentence pattern may refer to a sentence pattern combining balanced sentences and loose sentences, and the like.

In such case 5, by constructing the text using a sentence pattern consistent with the sentence pattern of the reading text, relevance between the text and the content currently presented in the reading text may be improved from an aspect of the sentence pattern, visual abruptness caused by presenting the text to the reader is reduced, the acceptance of the text by the reader is improved, and the interaction rate between the reader and the product content corresponding to the text is increased, thereby improving the conversion rate of the product content and enhancing the information processing effect.

The above case 1 to case 3 are possible implementations in the case where the text has the literary style feature associated with the content currently presented in the reading text, and the above case 4 and case 5 are possible implementations in the case where the text has the literary style feature associated with the entire reading text. Any combination of the above case 1 to case 5 may be made, which is not limited herein. The above case 1 to case 5 are only exemplary descriptions, and are not limited thereto. In some embodiments, that the text has the literary style feature associated with the reading text may also be other situations, for example, a character in a dialog in the text is any character involved in the reading text, a dialog sentence structure in the text is a dialog sentence structure with the highest usage frequency among all dialogs in the reading text, and the like.

The above case 1 to case 5 introduce the text from a perspective that the text has the literary style feature associated with the reading text. In an exemplary embodiment, in addition to having the literary style feature associated with the reading text, the text also needs to have a function of being capable of introducing the target product content, so that the reader may learn about the target product content to be presented according to the text.

In an exemplary embodiment, the text includes an introductory text corresponding to the target product content, and the introductory text is configured for introducing the target product content. Exemplarily, the introductory text may refer to promotional copy in the target product content, or may refer to a text obtained by adjusting the promotional copy in the target product content. For example, assuming that the target product content is configured for advertising an activity in Platform A, and the promotional copy in the target product content is "The whole store has an offer: spend 100 and get 20 off. During the Double Eleven sales, enjoy a non-stop shopping spree at 8 PM every night", the promotional copy may be directly used as the introductory text. Exemplarily, the introductory text may be part of the above-described first text or second text, or may be independent of the first text and the second text, which is not limited herein.

In an exemplary embodiment, the introductory text has a prominent presentation mark in a page where the text is presented. The prominent presentation mark may be set empirically, as long as it ensures that a presentation effect of the introductory text is different from that of other texts in the text. For example, the prominent presentation mark may be a cursor selection mark, or for another example, the prominent presentation mark may be a rectangular box selection mark, or the like.

The prominent presentation mark may attract much more attention from the reader, thereby attracting the reader to learn about the target product content to be inserted by paying attention to the introductory text in the text, improving the acceptance of the target product content by the reader, further improving the interaction rate between the reader and the target product content, and improving the conversion rate of the target product content.

In an exemplary embodiment, the introductory text includes a time-sensitive text, and the time-sensitive text is configured for indicating a valid time of the target product content. The embodiments herein do not limit a type of the time-sensitive text, which may be flexibly set according to a type of the target product content. For example, the time-sensitive text may be a countdown text indicating remaining valid time of the target product content, or may be a time-limited text directly indicating the valid time of the target product content, or the like. By providing the time-sensitive text in the introductory text, timeliness of the target product content may be emphasized in the introductory text, thereby stimulating a sense of urgency in the reader, prompting the reader to participate in an activity advertised by the target product content more quickly through interaction with the target product content, and improving the conversion rate of the target product content.

In a possible implementation, in addition to presenting the text in the reading interface, a prompt element is further presented, and the prompt element is configured for prompting that a text presented on a current page is the text. By presenting the prompt element, the reader may intuitively distinguish the text from the reading text in a case where the text is associated with the reading text in literary style, ensuring that the reader may accurately identify the text and improving the interaction experience of the reader.

A type and a form of the prompt element may be set empirically or flexibly adjusted according to requirements, which is not limited herein. In an exemplary embodiment, the prompt element includes at least one prompt sub-element, and different prompt sub-elements are configured for prompting, in different modes (such as different text contents and different forms), that a text presented on a current page is the text.

Exemplarily, the prompt element includes at least one of a prompt text, a prompt icon, or a prompt page corner. The prompt text prompts, through text, that the text presented on the current page is the text. Text of the prompt text may be flexibly set empirically. For example, the text of the prompt text may be "Relaxation Moment". The prompt icon prompts, through an icon, that the text presented on the current page is the text. For example, the prompt icon is an icon marked with text.

The prompt page corner is located in a region where any page corner of the current page is located, and the prompt page corner is in a folded state. That is, the prompt page corner prompts, through the folded state, that the text presented on the current page is the text. Which page corner region of the current page the prompt page corner is located in may be flexibly set according to requirements. For example, the prompt page corner is located in a region where a lower right page corner of the current page is located; or, the prompt page corner is located in a region where an upper right page corner of the current page is located, or the like.

In an exemplary embodiment, a presentation style of the text in the reading interface matches a presentation style of the reading text in the reading interface. The presentation style refers to a style utilized for presenting a text. Exemplarily, the presentation style includes, but is not limited to, a text presentation background, a text presentation font type, a text presentation font size, a text presentation font color, a text presentation line spacing, and the like. That the presentation style of the text matches the presentation style of the reading text may mean that the presentation style of the text is consistent with the presentation style of the reading text, or may mean that a difference between the presentation style of the text and the presentation style of the reading text is less than a difference threshold, and the difference threshold is set empirically.

By matching the presentation style of the text with the presentation style of the reading text, the text may simulate a User Interface (UI) style of the reading text, achieving an effect that a visual effect of the text converges with a visual effect of the reading text, keeping the text to be visually consistent with the reading text. By improving integration of the text with a reading environment of the reading text in terms of visual experience, visual abruptness caused by the text is reduced, and the interaction rate between the reader and the target product content is increased, thereby improving the conversion rate of the target product content.

Exemplarily, for a case where the presentation style of the text matches the presentation style of the reading text, it may be considered that the text is presented using a customized media style. The customized media style is a fixed UI style preset according to the presentation style of the reading text.

If the presentation style of the text matches the presentation style of the reading text, before presenting the text, the presentation style of the text needs to be determined first. For example, the presentation style of the reading text is used as the presentation style of the text; for another example, the presentation style of the reading text is finely adjusted, and a finely adjusted presentation style is used as the presentation style of the text. A mode of finely adjusting the presentation style of the reading text may be set empirically or flexibly adjusted according to requirements, which is not limited herein. Exemplarily, finely adjusting the presentation style of the reading text may refer to finely adjusting brightness of a text presentation background of the reading text, or may refer to finely adjusting text presentation font line spacing of the reading text, or the like.

In some embodiments, in addition to presenting the text in the reading interface, an advertising image or an advertising video may also be presented on the same page. The advertising image may be an image obtained by editing an original image in the target product content based on the literary style of the reading text, and the advertising video may refer to a video obtained by editing an original video in the target product content based on the literary style of the reading text. By presenting the advertising image or the advertising video, the reader may be more prominently prompted from multiple dimensions that the target product content is about to be presented, the resistance of the reader is reduced, the interaction rate between the reader and the target product content is increased, and the conversion rate of the target product content is improved.

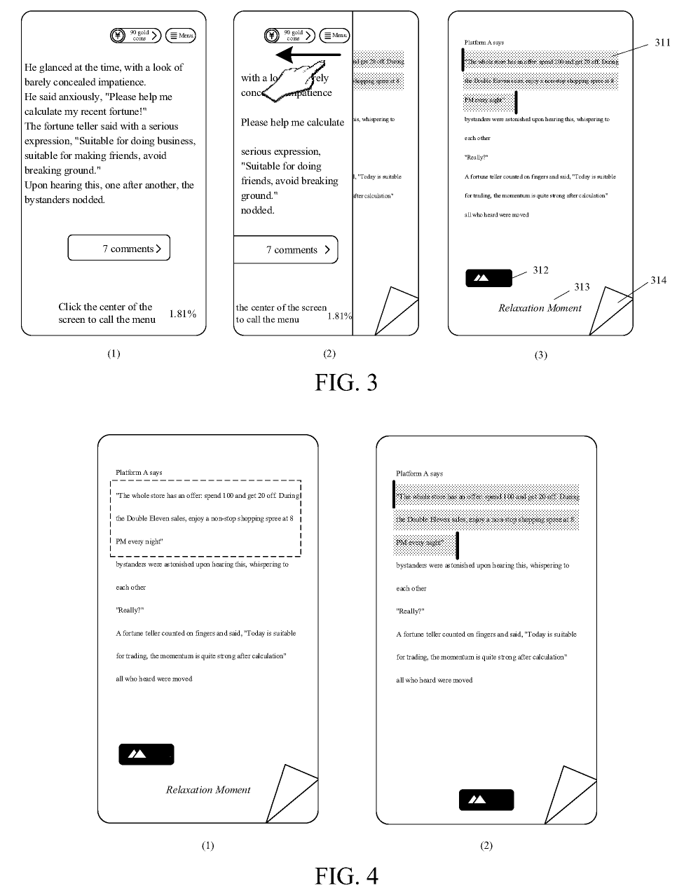

For example, the reading interface may be as shown in FIG. 3. As shown in (1) of FIG. 3, before the text is presented, the reading text is presented in the reading interface. The reader may switch reading text pages through a sliding operation from right to left. As shown in (2) of FIG. 3, if a page-turning event for switching a target reading text page displayed in the reading text is received, the target reading text page is switched to a page where the text is presented. After completely switching to the page where the text is presented, the reading interface is as shown in (3) of FIG. 3.

In (3) of FIG. 3, the text is presented in the reading interface, a presentation style of the text is consistent with a presentation style of the reading text, and a literary style of the text is associated with a literary style of the reading text. The text includes an introductory text 311 corresponding to the target product content. Content of the introductory text 311 is "The whole store has an offer: spend 100 and get 20 off. During the Double Eleven sales, enjoy a non-stop shopping spree at 8 PM every night". The introductory text 311 has a cursor selection mark (that is, a prominent presentation mark). Continuing to refer to (3) of FIG. 3, three prompt sub-elements are further presented on the page where the text is presented, namely, a prompt icon 312, a prompt text 313 with text "Relaxation Moment", and a prompt page corner 314 located in a region where a lower right page corner of the page where the text is presented is located and being in a folded state.

Continuing to refer to (3) of FIG. 3, in addition to including the introductory text 311 corresponding to the target product content, the text further includes a name of an advertiser (Platform A) and other information (said, bystanders were astonished upon hearing this, whispering to each other "Really?", a fortune teller counted on fingers and said, "Today is suitable for trading, the momentum is quite strong after calculation", all who heard were moved).

(3) of FIG. 3 is only an exemplary example of the page where the text is presented, and the embodiments of the disclosure are not limited thereto. For example, the page where the text is presented may also be as shown in FIG. 4. Referring to (1) of FIG. 4, on the page where the text is presented, a rectangular box selection mark may be utilized to mark the introductory text; and referring to (2) of FIG. 4, on the page where the text is presented, only one type of prompt sub-element, namely a prompt icon, is presented.

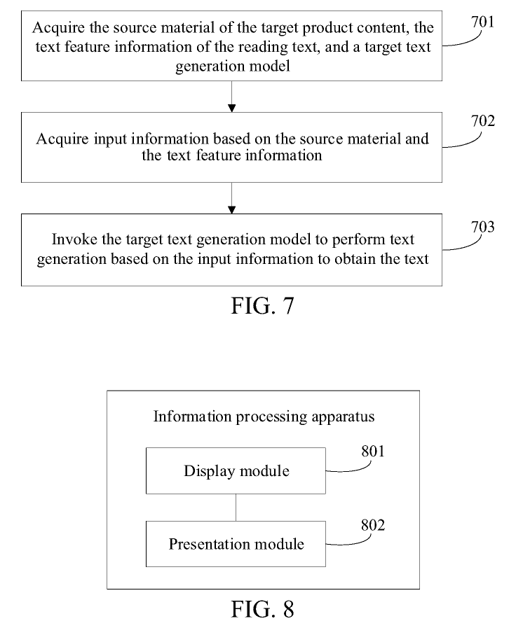

Before presenting the text, the text needs to be acquired first. An acquisition mode of the text may be flexibly set according to requirements. In a possible implementation, the text is generated by a natural language model based on a source material of the target product content and text feature information of the reading text. The natural language model is a model having a text generation function, and the text feature information of the reading text is configured for characterizing the reading text and may reflect a literary style of the reading text. A process of generating the text through the natural language model based on the source material of the target product content and the text feature information of the reading text may be implemented by a terminal or by a server, which is not limited herein. The process of generating the text through the natural language model based on the source material of the target product content and the text feature information of the reading text is described in detail in the embodiment shown in FIG. 7, and details are not described herein again.

In another implementation, the text is acquired from a target platform by invoking an interface of the target platform, where the target platform is configured for generating the text based on the source material of the target product content and the text feature information of the reading text. The target platform is an intermediary platform between an advertiser and the text reading platform. That is, the target platform may acquire the source material of the target product content from the advertiser, and may also acquire the text feature information of the reading text from the text reading platform. The target platform may generate the text based on the acquired source material of the target product content and the text feature information of the reading text. After acquiring the text, the target platform encapsulates the text in an SDK, and provides an interface of the SDK (such as an Application Programming Interface (API)) for a terminal, and the terminal invokes the interface of the target platform to acquire the text from the target platform.

Exemplarily, a form in which the target platform provides the text may be: providing content of the text and a presentation style of the text. In such a case, before presenting the text, the terminal needs to perform page rendering according to the acquired content and the presentation style of the text, and then implement presentation of the text by presenting a rendered page. Exemplarily, the form in which the target platform provides the text may also be: providing data corresponding to a page rendered according to the presentation style of the text and the content of the text. In such a case, the terminal does not need to perform rendering again, and may directly implement presentation of the text by loading the data corresponding to the page provided by the target platform.

In another implementation, the text is acquired based on a text generation template. Exemplarily, a process of acquiring the text based on the text generation template includes: acquiring the text generation template, where the text generation template includes a to-be-filled text region and a fixed text, and the fixed text has a literary style feature associated with the reading text; determining a filling text based on the target product content; and filling the to-be-filled text region in the text generation template with the filling text, and using a filled text generation template as the text.

The text generation template includes the to-be-filled region and the fixed text having the literary style feature associated with the reading text, and the to-be-filled region is configured for being filled with information related to the target product content, to ensure that the generated advertising text may play a role of introducing the target product content.

Exemplarily, a process of determining the filling text based on the target product content may refer to using a name of an advertiser corresponding to the target product content and an introductory text corresponding to the target product content as the filling text. After filling the to-be-filled text region in the text generation template with the filling text, the text is obtained.

The text generation template may be preset according to requirements of the text. In an exemplary embodiment, text generation templates respectively corresponding to multiple literary styles may be set, and a text generation template corresponding to the literary style of the reading text is selected from the text generation templates respectively corresponding to the multiple literary styles to generate the text.

In an exemplary embodiment, content of the text matches object data of the reader. The object data of the reader refers to data related to the reader. A type of the object data may be set empirically or flexibly adjusted according to requirements. Exemplarily, the object data may include, but is not limited to, an age, a gender, interests and hobbies, consumption habits, reading preference, historical interaction with product content, and the like of the reader. The object data may be acquired from registration information, browsing records, purchase records, and the like of the reader, with authorization of the reader. Exemplarily, a portrait of the reader may be constructed based on the object data of the reader. The portrait of the reader is a mode of concretely expressing an image of the reader through tags.

If the content of the text matches the object data of the reader, advertising texts tailored for different readers may be generated, ensuring that the content of the text is content that the reader is interested in, thereby further increasing the attention of the reader to the text, increasing the interaction rate between the reader and the target product content corresponding to the text, and improving the conversion rate of the target product content.

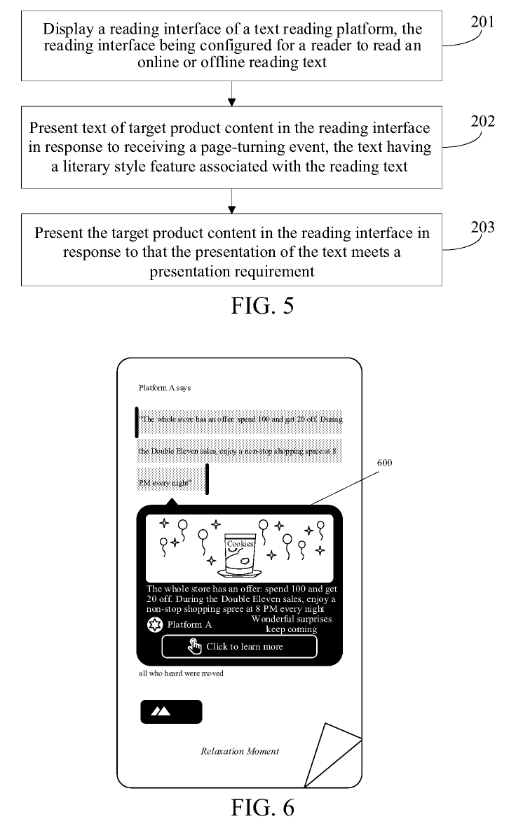

In an exemplary embodiment, as shown in FIG. 5, after presenting the text, the method further includes:

Operation 203: Present the target product content in the reading interface in response to that the presentation of the text meets a presentation requirement.

After presenting the text, whether the presentation of the text meets the presentation requirement is determined. In a case that the presentation of the text meets the presentation requirement, the target product content is presented in the reading interface. That the presentation of the text meets the presentation requirement is configured for indicating that the target product content needs to be presented in the reading interface. That the presentation of the text meets the presentation requirement may be set empirically, or may be flexibly adjusted according to a type of the reading text and the like, which is not limited herein.

In a possible implementation, that the presentation of the text meets the presentation requirement includes that a presentation duration of the text reaches a duration threshold, or a switching operation for the text is acquired. The duration threshold is set empirically, or flexibly adjusted according to the type of the reading text and the like, which is not limited herein. For example, the duration threshold may be 2 seconds, or may be 3 seconds, or the like. The switching operation for the text may refer to a sliding operation generated by the reader on the page where the text is presented, or may refer to a triggering operation performed by the reader on a switching control in the page where the text is presented, or the like. It supports both automatically controlling whether to present the target product content according to the presentation duration and controlling whether to present the target product content according to an operation of the reader. A mode of controlling whether to present the target product content is relatively comprehensive, which may both comply with the needs of the reader and avoid an excessively long presentation duration of the text, thereby ensuring a presentation effect of the target product content, improving the interaction rate between the reader and the target product content, and further improving the conversion rate of the target product content.

In a case that the presentation of the text meets the presentation requirement, the target product content is presented in the reading interface. Exemplarily, presenting the target product content in the reading interface refers to presenting a source material of the target product content in the reading interface. That is, when presenting the target product content, the source material provided by the advertiser is not modified, so as to ensure complete exposure of the source material of the target product content provided by the advertiser and satisfy a presentation requirement of the advertiser on the target product content. The source material of the target product content may include at least one of text, an image, or a video. Exemplarily, before presenting the target product content, the source material of the target product content needs to be acquired first. The terminal may extract the source material of the target product content from a local storage, or may acquire the source material of the target product content from a server, a target platform, or the advertiser, which is not limited herein.

In a possible implementation, an implementation process of presenting the target product content in the reading interface includes: popping up an product content presentation slot in the page where the text is presented; and presenting the target product content in the product content presentation slot. When the target product content needs to be presented, presenting the target product content in the product content presentation slot in the page where the text is presented may enable the target product content to be overlaid on the page where the text is presented, thereby visually and intuitively reflecting relevance between the text and the target product content, improving the acceptance of the target product content by the reader, further improving the interaction rate between the reader and the target product content, and improving the conversion rate of the target product content.

In an exemplary embodiment, an implementation mode of popping up the product content presentation slot in the page where the text is presented is: popping up the product content presentation slot in the page where the text is presented through an animation effect. The animation effect matches the reading text. That is, popping up the product content presentation slot in the page where the text is presented through the animation effect matching the reading text may better integrate a pop-up effect of the product content presentation slot with a reading scene of the reading text, reduce visual abruptness caused by popping up the product content presentation slot to the reader, improve the acceptance of the target product content by the reader, further improve the interaction rate between the reader and the target product content, and improve the conversion rate of the target product content.

Exemplarily, that the animation effect matches the reading text may mean that the animation effect matches a text type of the reading text. The terminal may pre-store or acquire from the server a corresponding relationship between a text type and an animation effect. The terminal may search the corresponding relationship for an animation effect corresponding to the text type of the reading text, and use the found animation effect as the animation effect utilized for popping up the product content presentation slot.

Exemplarily, that the animation effect matches the reading text may also mean that the animation effect matches content currently presented in the reading text. The terminal may input the content currently presented in the reading text into an animation effect determination model, and use an animation effect outputted by the animation effect determination model as the animation effect utilized for popping up the product content presentation slot. The animation effect determination model has a function of determining, according to inputted content, probabilities respectively corresponding to multiple candidate animation effects, and outputting an animation effect with the highest probability. The animation effect determination model may be obtained through supervised training using sample content and a standard animation effect corresponding to the sample content.

In another possible implementation, an implementation process of presenting the target product content in the reading interface includes: hiding the text, and presenting the target product content at a specified position in the reading interface. The specified position may be set empirically or flexibly adjusted according to actual requirements, which is not limited herein. For example, the specified position may be a center position of the reading interface, or may be a bottom position of the reading interface, or may be a top position of the reading interface, or the like.

Exemplarily, in the reading interface, in addition to presenting the source material of the target product content, an interactive control is further presented, and the interactive control is configured for the reader to interact with the target product content. A form of the interactive control may be an icon, or may be a button, or the like. In some embodiments, the interactive control may also be referred to as a call-to-action button. After presenting the interactive control, the method further includes: jumping to an application program or a web page associated with the target product content in response to a triggering operation on the interactive control. When providing the target product content, the advertiser may provide the application program or the web page associated with the target product content at the same time, so that after acquiring the triggering operation on the interactive control, the terminal may directly jump to the application program or the web page associated with the target product content.

In a possible implementation, similar to the page where the text is presented, a page where the target product content is presented also has a prompt page corner in a folded state. Exemplarily, the page corners in the folded state in the page where the text is presented and the page where the target product content is presented are at the same position, so as to improve a visual effect.

For example, referring to FIG. 6, when the presentation of the text meets the presentation requirement, the target product content and the interactive control are presented in an product content presentation slot 600 in the page where the text is presented. The target product content presented in the product content presentation slot 600 includes source materials such as an image, text, and a name of the advertiser. The interactive control is marked with text "Click to learn more".

In a possible implementation, in addition to presenting the target product content in the reading interface, historical interaction information corresponding to the target product content is further presented. The historical interaction information corresponding to the target product content is configured for indicating historical interaction of an interaction object with the target product content. Based on this, incorporating the historical interaction information as a social element to the presentation of the target product content may increase credibility of the target product content, improve a possibility that the reader interacts with the target product content, and improve the conversion rate of the target product content.

Exemplarily, the historical interaction information corresponding to the target product content may include avatars and nicknames of interaction objects who have interacted with the target product content, evaluations on the target product content by the interaction objects, recommendation information of the target product content by the interaction objects, and the like. Exemplarily, when presenting the historical interaction information, relatively brief information such as avatars and nicknames of the interaction objects may be presented first, and after the brief information is triggered, evaluations and recommendation information of the interaction objects may be presented, thereby avoiding interference of excessive information with the target product content and improving the presentation effect.

In an exemplary embodiment, after presenting the text, interaction data of the reader with personalized advertising texts during a reading process, such as a click-through rate, a dwell time, or the like, may also be collected. By analyzing the data, a text generation model and a presentation strategy are continuously optimized, thereby improving attractiveness and a conversion rate of advertisements. Meanwhile, the data is fed back to the advertiser and the text reading platform, so that the advertiser and the text reading platform may learn about an advertising effect and optimize an advertising strategy.

The information processing method provided in one or more embodiments may be an advertisement presentation method for optimizing an outer advertising form. By first presenting the text having the literary style feature associated with the reading text and then presenting the target product content, nativization of the target product content may be increased, so that the target product content becomes a native product content, thereby creating an advertisement with a strong sense of plot and scenario. Readers in a reading scene are more sensitive to text and plot. Therefore, creating advertisements with a strong sense of plot and scenario may make the advertisements more nativized. Advertisements with strong nativization may reduce the resistance of the readers, stimulate the reading interest of the readers, improve the acceptance of the advertisements by the readers, better attract the readers, and guide the readers to actively interact with the product content, thereby improving the click-through rate and the conversion rate of the advertisements. In addition, a presentation mode of presenting the text first and then the product content is better integrated with the scene and has a stronger sense of fun, which may help the advertiser better convey information, attract the attention of the readers, and improve the conversion rate of the advertisements.

The method provided in one or more embodiments may generate advertisements of certain template or tailored for different readers by understanding the literary style of the reading text, creating more immersive and distinctive advertising forms in a reading scene, improving overall interaction, feedback, and presentation effects of the advertisements, so as to enable the reader to encounter more interesting advertisements better fitting the scene during an immersive reading process, and promote the reader to actively interact with the advertisements. Personalized texts for characteristics of different readers are generated according to the portrait of the reader and key information of the product content. Such texts tailored for different readers may better meet needs and interests of the readers, thereby improving attractiveness and interactivity of the advertisements.

The target product content presented in this application may be referred to as a soft-text advertisement. After swiping open an advertisement page, the reader accustomed to reading text from left to right and from top to bottom first sees the text (which may also be referred to as advertising copy), and then sees the target product content (such as an advertising image and an advertising video) and a button (such as a Call to Action (CTA) button). By using the form of the reading text and providing a virtual plot to guide the reader to interact with the target product content, the reader who is skimming through is attracted by the content, and the attention of the reader is captured in a natively eye-catching mode, thus improving the conversion rate of the target product content.

In one or more embodiments, when an advertisement needs to be presented, the text for the product content is presented in the reading interface. The text has strong literary style relevance to the reading text and may be better integrated into the reading scene, which helps reduce the visual abruptness of the reader, improve the acceptance of the text by the reader, and increase the interaction rate between the reader and the product content corresponding to the text, thereby improving the conversion rate of the product content and enhancing the information processing effect.

In addition, by constructing the text using a dialog of a character associated with the character involved in the content currently presented in the reading text, using a dialog sentence structure matching the dialog sentence structure in the content currently presented in the reading text, using a dialog of a character in the reading text having a dialog tone matching the personality of the character, describing a scene associated with the scene involved in the content currently presented in the reading text, using a language style type consistent with the language style type of the reading text, using a sentence pattern consistent with the sentence pattern of the reading text and the like, relevance between the text and the content currently presented in the reading text may be improved from aspects of the dialog character, the dialog sentence structure, the dialog tone, the scene, the language style, the sentence pattern and the like, visual abruptness caused by presenting the text to the reader is reduced, the acceptance of the text by the reader is improved, and the interaction rate between the reader and the product content corresponding to the text is increased, thereby improving the conversion rate of the product content and the information processing effect.

The same target product content corresponds to different texts for different reading texts, and the text has relatively high presentation flexibility, thereby helping improve the presentation effect of the text. In addition, the text may be automatically generated by a natural language model to ensure the quality of the text.

By presenting the prompt element, the reader may intuitively distinguish the text from the reading text in a case where the text has a literary style feature associated with the reading text, ensuring that the reader may accurately identify the text and improving the interaction experience of the reader.

Providing the prominent presentation mark for the introductory text may attract much more attention from the reader, thereby attracting the reader to have an expectation for target product content to be subsequently presented by paying attention to the introductory text in the text, reducing visual abruptness caused by the target product content, improving the acceptance of the target product content by the reader, further improving the interaction rate between the reader and the target product content, and improving the conversion rate of the target product content. By providing the time-sensitive text in the introductory text, timeliness of the target product content may be emphasized in the introductory text, thereby stimulating a sense of urgency in the reader, prompting the reader to participate in an activity advertised by the target product content more quickly through interaction with the target product content, and improving the conversion rate of the target product content.

By matching the presentation style of the text with the presentation style of the reading text, the text may simulate a UI style of the reading text, achieving an effect that a visual effect of the text converges with a visual effect of the reading text, keeping the text to be visually consistent with the reading text. By improving integration of the text with a reading environment of the reading text in terms of visual experience, visual abruptness caused by the text is reduced, and the interaction rate between the reader and the target product content is increased, thereby improving the conversion rate of the target product content.

In a case that the presentation of the text meets the presentation requirement, the target product content is presented in the reading interface. This may ensure complete exposure of the source material of the target product content provided by the advertiser and satisfy a presentation requirement of the advertiser on the target product content. When the target product content needs to be presented, presenting the target product content in the product content presentation slot in the page where the text is presented may enable the target product content to be overlaid on the page where the text is presented, thereby visually and intuitively reflecting relevance between the text and the target product content, improving the acceptance of the target product content by the reader, further improving the interaction rate between the reader and the target product content, and improving the conversion rate of the target product content.

Popping up the product content presentation slot in the page where the text is presented through the animation effect matching the reading text may better integrate a pop-up effect of the product content presentation slot with a reading scene of the reading text, reduce visual abruptness caused by popping up the product content presentation slot to the reader, improve the acceptance of the target product content by the reader, further improve the interaction rate between the reader and the target product content, and improve the conversion rate of the target product content.

Incorporating the historical interaction information as a social element to the presentation of the target product content may increase credibility of the target product content, improve a possibility that the reader interacts with the target product content, and improve the conversion rate of the target product content.

One or more embodiments provides a method for generating text by a natural language model based on a source material of a target product content and text feature information of a reading text. The method is performed by a computer device. Exemplarily, the computer device may be a terminal or a server. The embodiments of this application are described by taking the method being performed by a terminal as an example. As shown in FIG. 7, the method for generating the text by the natural language model based on the source material of the target product content and the text feature information of the reading text may include the following operation 701 to operation 703.

Operation 701: Acquire the source material of the target product content, the text feature information of the reading text, and a target text generation model.

The source material of the target product content may be provided by an advertiser to a text reading platform, so that the terminal may acquire the source material of the target product content from the text reading platform. The source material of the target product content is a material provided by the advertiser for introducing the target product content. The source material of the target product content may include, but is not limited to, at least one of text, an image, or a video.

The text feature information of the reading text is information configured for characterizing a feature of the reading text. According to the text feature information, the target text generation model may learn a literary style of the reading text, thereby generating text having a literary style feature matching the reading text.

In an exemplary embodiment, if that the text has the literary style feature associated with the reading text includes that the text has a literary style feature associated with the entire reading text, the text feature information includes information configured for characterizing a feature of the entire reading text; and if that the text has the literary style feature associated with the reading text includes that the text has a literary style feature associated with content currently presented in the reading text, the text feature information includes information configured for characterizing a feature of the content currently presented in the reading text.

A specific situation of the text feature information may be related to a specific situation where the text has the literary style feature associated with the reading text. The embodiments of the disclosure do not limit a type of the text feature information of the reading text. Next, specific situations of the text feature information will be exemplarily described with reference to case 1 to case 5 where the text has the literary style feature associated with the reading text in the embodiment shown in FIG. 2.

If the text having the literary style feature associated with the reading text is case 1 in the embodiment shown in FIG. 2, that is, the text includes a first text in a dialog form, and the associated literary style feature includes that a character in a dialog in the first text is associated with a character involved in content currently presented in the reading text, then the text feature information includes identification information of the character involved in the content currently presented in the reading text and character relationship information of the reading text.

The identification information of the character involved in the content currently presented is configured for identifying the character involved in the content currently presented. For example, the identification information of the character involved in the content currently presented may refer to a name, a nickname, or the like of the character involved in the content currently presented. The identification information of the character involved in the content currently presented may be extracted from the content currently presented.

The character relationship information of the reading text is configured for indicating an association relationship among characters involved in the reading text. The character relationship information of the reading text may be acquired from the text reading platform. The character relationship information stored in the text reading platform may be information submitted to the text reading platform by the author of the reading text, or may be information obtained by a developer of the text reading platform through analyzing the reading text.

In an exemplary embodiment, in a case where the text having the literary style feature associated with the reading text is case 1 in the embodiment shown in FIG. 2, a dialog tone of the character in the dialog in the first text may also match a personality of the character described in the reading text. In such a case, the text feature information further includes character personality characterization content in the reading text.

The character personality characterization content is configured for characterizing the personality of the character in the reading text. Character characterization content of any character includes at least one of dialog content of the any character in the reading text, an introduction of the any character provided by an author of the reading text, or description content of the any character in the reading text. Exemplarily, the dialog content of any character in the reading text may refer to all dialog content of the any character in the reading text, or may refer to dialog content of the any character in the reading text with a number of dialog words exceeding a word count threshold or the like. Exemplarily, the description content of the any character in the reading text may refer to content describing at least one of clothing, appearance, height, action, or expression of the any character in the reading text. The character personality characterization content may be provided by the author of the reading text or extracted from the reading text.

If the text having the literary style feature associated with the reading text is case 2 in the embodiment shown in FIG. 2, that is, the text includes a first text in a dialog form, and the associated literary style feature includes that a dialog sentence structure of the first text matches a dialog sentence structure in the content currently presented in the reading text, then the text feature information includes a dialog text in the content currently presented in the reading text.

The dialog text is configured for characterizing the dialog sentence structure in the content currently presented, and the dialog sentence structure is configured for indicating a sequence of a character description and dialog content. Exemplarily, the dialog text in the content currently presented in the reading text may refer to a text composed of part or all of the dialog content in the content currently presented. The dialog text in the content currently presented may be extracted from the content currently presented.

If the text having the literary style feature associated with the reading text is case 3 in the embodiment shown in FIG. 2, that is, the text includes a second text in a scene description form, and the associated literary style feature includes that a scene described in the second text is associated with a scene involved in the content currently presented in the reading text, then the text feature information includes a scene description text in the content currently presented in the reading text.

The scene description text is configured for characterizing the scene involved in the content currently presented. Exemplarily, the scene description text in the content currently presented may refer to a text composed of part or all of content configured for describing a scene in the content currently presented.

If the text having the literary style feature associated with the reading text is case 4 in the embodiment shown in FIG. 2, that is, the associated literary style feature includes that a language style type of the text is consistent with a language style type of the reading text, then the text feature information includes identification information of the language style type of the reading text.

The identification information of the language style type of the reading text is configured for identifying the language style type of the reading text. The language style type of the reading text is configured for indicating a style of writing the reading text. The identification information of the language style type of the reading text may be obtained from a tag of the reading text. The tag of the reading text refers to a tag marked on the reading text by the author of the reading text or by the text reading platform for reflecting a characteristic of the reading text.

If the text having the literary style feature associated with the reading text is case 5 in the embodiment shown in FIG. 2, that is, the associated literary style feature includes that a sentence pattern of the text is the same as a sentence pattern of the reading text, then the text feature information includes identification information of the sentence pattern of the reading text.

The identification information of the sentence pattern of the reading text is configured for identifying the sentence pattern of the reading text. Exemplarily, the identification information of the sentence pattern may refer to information directly configured for identifying a sentence pattern, for example, a balanced sentence pattern, a loose sentence pattern, and the like. Exemplarily, the identification information of the sentence pattern may also refer to one or more paragraphs of content in the reading text and the like. The identification information of the sentence pattern may be extracted from the reading text, or obtained by analyzing content of the reading text.

Case 1 to case 5 where the text has the literary style feature associated with the reading text in the embodiment shown in FIG. 2 may be arbitrarily combined, and information included in the text feature information described above may also be arbitrarily combined.

For example, if the text having the literary style feature associated with the reading text includes case 1 and case 2, that is, the associated literary style feature further includes that the character in the dialog in the first text in the text is associated with the character involved in the content currently presented in the reading text, the dialog tone of the character in the dialog in the first text matches the personality of the character described in the reading text, and the dialog sentence structure of the first text matches the dialog sentence structure in the content currently presented, then the text feature information includes the identification information of the character involved in the content currently presented, the character relationship information of the reading text, and the character personality characterization content in the reading text.

For another example, if the text having the literary style feature associated with the reading text includes case 3 to case 5, that is, the scene described in the second text in the text is associated with the scene involved in the content currently presented in the reading text, the language style type of the text is consistent with the language style type of the reading text, and the sentence pattern of the text is the same as the sentence pattern of the reading text, then the text feature information includes the scene description text in the content currently presented, the identification information of the language style type of the reading text, and the identification information of the sentence pattern of the reading text.

The text feature information described above is only an exemplary description with reference to the five exemplary cases where the text has the literary style feature associated with the reading text. The embodiments of the disclosure are not limited thereto. When the text having the literary style feature associated with the reading text is in other cases, the text feature information may also be flexibly changed. In some embodiments, in addition to the information mentioned above, the text feature information may further include basic information of the reading text, for example, a name of the reading text, an author of the reading text, a text type of the reading text, a chapter directory of the reading text, and the like, which are not listed here one by one.

The target text generation model is a natural language model having a function of generating, according to the source material of the target product content and the text feature information of the reading text, text having a literary style feature associated with the reading text. This application does not limit a model architecture of the target text generation model, as long as it may process a text generation task. Exemplarily, the model architecture of the target text generation model may be a Recurrent Neural Network (RNN), a Long Short-Term Memory (LSTM), a Gated Recurrent Unit (GRU), Transformer, and the like. These model architectures have advantages in processing sequence data and may capture long-distance dependency relationships in texts. For example, the model architecture of the Transformer may specifically refer to Bidirectional Encoder Representations from Transformers (BERT), Generative Pre-Trained Transformer (GPT), and the like.

The terminal may acquire the target text generation model from a server, or may extract the target text generation model from a local storage. The target text generation model may be obtained by the terminal or the server through supervised training. A process of obtaining the target text generation model through training will be described below, and details are not described herein again.

In an exemplary embodiment, if the content of the text matches object data of the reader, before performing operation 702, the object data of the reader further needs to be acquired. The object data of the reader refers to data related to the reader. A type of the object data may be set empirically or flexibly adjusted according to requirements. Exemplarily, the object data may include, but is not limited to, an age, a gender, interests and hobbies, consumption habits, reading preference, historical interaction with product content, and the like of the reader. The object data may be acquired from registration information, browsing records, purchase records, and the like of the reader, with authorization of the reader.

Operation 702: Acquire input information based on the source material and the text feature information.

The input information refers to information that needs to be inputted into the target text generation model. In an exemplary embodiment, acquiring the input information based on the source material and the text feature information may refer to directly acquiring the input information based on the source material and the text feature information. Exemplarily, an implementation process of directly acquiring the input information based on the source material and the text feature information may be: acquiring a first feature corresponding to the source material of the target product content and a second feature corresponding to the text feature information; and acquiring the input information based on the first feature and the second feature. For example, the first feature and the second feature are used as the input information; for another example, a concatenated feature of the first feature and the second feature is used as the input information; and for another example, corresponding elements of the first feature and the second feature are added, and an added feature is used as the input information. A concatenation order of multiple features may be set empirically or flexibly adjusted according to requirements, which is not limited herein. In addition, before performing element addition on multiple features, the multiple features need to be expanded to the same dimension.

Exemplarily, source materials such as text, an image, and a video of the target product content are all converted into a form that may be directly processed by a model, to obtain the first feature; and the text feature information is converted into the form that may be directly processed by the model, to obtain the second feature. Exemplarily, a feature extraction model may be utilized to respectively extract the first feature of the source material of the target product content and the second feature of the text feature information.

Exemplarily, for a case where both the source material of the target product content and the text feature information are in a text form, the source material of the target product content may be subjected to word segmentation processing to obtain multiple first words, and features corresponding to the multiple first words are concatenated to obtain the first feature; and the text feature information may be subjected to word segmentation processing to obtain multiple second words, and features corresponding to the multiple second words are concatenated to obtain the second feature. In some embodiments, a word feature table may be constructed in advance, and the word feature table records features corresponding to candidate words. The candidate words may be extracted from a word library, or may be extracted from a network, or the like. A feature corresponding to a word is configured for characterizing the word. For example, the feature corresponding to the word may be a one-hot feature.

In an exemplary embodiment, acquiring the input information based on the source material and the text feature information may also refer to acquiring the input information based on the source material, the text feature information, and the object data of the reader. The input information acquired in such a mode includes the object data of the reader, enabling the model to generate text matching the object data of the reader, improving matching between the text and interests of the reader, improving the acceptance of the text by the reader, and further improving the conversion rate of the product content.

Exemplarily, an implementation process of acquiring the input information based on the source material, the text feature information, and the object data of the reader may be: acquiring a first feature corresponding to the source material of the target product content, a second feature corresponding to the text feature information, and a third feature corresponding to the object data; and acquiring the input information based on the first feature, the second feature, and the third feature. Exemplarily, the feature extraction model may be invoked to extract the third feature corresponding to the object data of the reader.

Operation 703: Invoke the target text generation model to perform text generation based on the input information to obtain the text.

After acquiring the input information, the input information is inputted into the target text generation model to obtain the text with the assistance of the target text generation model. In an exemplary embodiment, a process of invoking the target text generation model to perform text generation based on the input information to obtain the text includes: invoking the target text generation model to acquire a target feature based on the input information, and performing text generation based on the target feature to obtain a first text; and acquiring the text based on the first text outputted by the target text generation model.

Exemplarily, invoking the target text generation model to acquire the target feature based on the input information may refer to invoking the target text generation model to perform feature extraction on the input information to obtain the target feature. Exemplarily, a fully connection layer (or referred to as a dense connection layer) may be set in an input layer of the target text generation model, and the fully connection layer may perform feature extraction on the input information to form the target feature.

The source material of the target product content, the text feature information, the object data of the reader, and the like are preprocessed to conform to an input requirement of the model, and the preprocessed input information is inputted into a trained target text generation model. The model generates words one by one according to the input information, this process continues until a complete piece of copy is formed, and the copy is the first text. When generating a word at certain position, what is usually outputted is a probability distribution, representing a probability that each candidate word appears at the position under a given context, and a candidate word corresponding to the highest probability in the probability distribution is used as the word at the position.

Exemplarily, acquiring the text based on the first text may refer to using the first text as the text. Such a mode may improve efficiency of acquiring the text based on the first text.

Exemplarily, acquiring the text based on the first text may also refer to repairing the first text to obtain the text. In some embodiments, repairing the first text may include, but is not limited to, removing repeated words, completing incomplete sentences, and supplementing missing text. In some embodiments, the missing text may refer to a name of an advertiser, an introductory text corresponding to the target product content, and the like. Such a mode may ensure quality of the text.

The target text generation model is obtained by training an initial text generation model based on a difference between a predicted text and a standard text. The predicted text is obtained by invoking the initial text generation model to perform text generation based on sample input information. The sample input information is determined based on a sample material of a sample product content and sample text feature information of a sample reading text. The standard text has a literary style feature associated with the sample reading text. Taking a process of obtaining the target text generation model through training being performed by a terminal as an example, the process of obtaining the target text generation model through training includes the following operation A to operation D.

Operation A: Acquire the sample material of the sample product content, the sample text feature information of the sample reading text, and the standard text.

The sample material of the sample product content may be extracted from an product content library. An advertising material library includes materials of various product contents, for example, materials of product contents provided by various types of advertisers, materials of product contents corresponding to various products, materials of product contents corresponding to various services, and the like. The materials of the product contents in the advertising material library may be acquired from a media platform, an advertising case library, or a network. In some embodiments, the sample material of the sample product content may be obtained by preprocessing materials of product contents in the advertising material library (for example, removing special symbols, word segmentation, part-of-speech tagging) and the like.

The sample text feature information of the sample reading text may be extracted from a reading text library. Reading texts in the reading text library may include reading texts of different types, different plot settings and different literary styles, as well as text feature information of each reading text. The reading texts in the reading text library may help a model learn literary styles of various reading texts. The reading texts in the reading text library may be acquired from a public reading text database, a website, an e-book resource, and the like. The sample text feature information of the reading texts in the reading text library may be extracted from tags or content of the reading texts in the reading text library.

The standard text is configured for introducing a sample target product content, and the standard text has a literary style feature matching the sample reading text. The standard text is a target that the text generation model needs to learn. By setting the standard text, the text generation model may be enabled to learn to combine a material of an product content with a literary style of a reading text. The standard text is a text that integrates the literary style of the sample reading text into the material of the product content. The standard text may be manually written, or may be generated using a rule or an algorithm, which is not limited herein.

For example, if a type of the sample reading text is fantasy, the sample text feature information is "He drew his sword, preparing to fight the dragon", an advertiser corresponding to the sample product content is Platform A, and text in the sample product content is "spend 100 and get 20 off", then the standard text may be "In the midst of this fierce battle, why don't warriors come to Platform A, with the power of spending 100 and getting 20 off, to buy more powerful props and help you?".

Exemplarily, the sample material of one sample product content, the sample text feature information of one sample reading text, and one corresponding standard text may be used as one piece of sample data. A data set including multiple pieces of sample data may be constructed in advance. The data set may be divided into a training set, a validation set, and a test set. For example, division may be performed according to a ratio of 80% training set, 10% validation set, and 10% test set. In a process of training the text generation model, sample data may be extracted from the training set for training.

In an exemplary embodiment, for a case where the content of the text matches the object data of the reader, in the process of training the text generation model, sample object data further needs to be acquired. The sample object data may be extracted from data generated by the reader of the reading text. For example, the sample object data may be represented as a portrait of a sample object, and the portrait of the sample object is constructed by analyzing behavior data of the reader in a process of reading a sample reading text. The portrait of the sample object may include information such as interests and hobbies of the reader, reading preference, historical interaction with the target product content, and the like.

Operation B: Determine sample input information based on the sample material of the sample product content and the sample text feature information.

Operation C: Invoke an initial text generation model to perform text generation based on the sample input information to obtain a predicted text.

Implementation principles of the above operation B and operation C are the same as implementation principles of operation 702 and operation 703, and details are not described herein again.

Operation D: Train the initial text generation model based on a difference between the predicted text and the standard text to obtain a target text generation model.

Exemplarily, a process of training the initial text generation model based on the difference between the predicted text and the standard text to obtain the target text generation model includes: determining a first loss based on the difference between the predicted text and the standard text; calculating a gradient of the first loss relative to parameters of the initial text generation model; using the gradient to reversely update the parameters of the initial text generation model to obtain an updated text generation model; and if the updated text generation model satisfies a training termination condition, using the updated text generation model as the target text generation model. If the updated text generation model does not satisfy the training termination condition, acquiring a new first loss based on the updated text generation model, and reversely updating the parameters of the updated text generation model based on the new first loss, and so on, until an obtained text generation model satisfies the training termination condition, and using the obtained text generation model as the target text generation model.

Exemplarily, a mode of determining the first loss based on the difference between the predicted text and the standard text may be: determining the first loss by using a loss function based on the difference between the predicted text and the standard text. The loss function may refer to a cross-entropy loss function, a mean squared error loss function, or the like. The first loss is configured for measuring the difference between the predicted text obtained based on the model and the standard text. Updating the parameters of the text generation model may refer to updating the parameters of the text generation model by using an optimizer. For example, the optimizer may be an Adaptive Moment Estimation (Adam) optimizer, a Root Mean Square Propagation (RMSProp) optimizer, or the like.

Whether the updated text generation model satisfies the training termination condition may be set empirically or flexibly adjusted according to requirements, which is not limited herein. Exemplarily, that the updated text generation model satisfies the training termination condition may include any one of the following: a first loss based on which the updated text generation model is obtained is not greater than a loss threshold; the first loss based on which the updated text generation model is obtained converges; and a number of times of model parameter updates that have been performed when the updated text generation model is acquired reaches a times threshold. The loss threshold and the times threshold may be set empirically or flexibly adjusted according to requirements.

Exemplarily, hyper-parameters of the initial text generation model may be set according to task requirements, a calculation amount, and the like. For example, the hyper-parameters may include a number of model layers, a number of hidden units, a learning rate, a batch size, and the like. In practical application, relatively suitable hyper-parameter settings may be found through multiple attempts and adjustments.

In a process of training the text generation model, performance of the text generation model may be periodically evaluated on the validation set. Hyper-parameters of the text generation model, such as the learning rate, the number of model layers, and the number of hidden units, are adjusted according to a validation result. If it is found that the text generation model performs well on the training set but poorly on the validation set, an overfitting phenomenon may have occurred. Training data may be increased or a regularization method may be utilized to alleviate overfitting. When the text generation model achieves satisfactory performance on the validation set, trained model parameters are saved to obtain the target text generation model. In some embodiments, after training is completed, the text generation model may be evaluated to ensure that a text generated by the text generation model has relatively high nativization and attractiveness.

In one or more embodiments, the target text generation model generates the text by understanding the source material of the target product content and the text feature information of the reading text. The target text generation model is obtained through training under supervision of the standard text, which helps ensure generation quality of the text, improve attractiveness of the text to the reader, and further improve the conversion rate of the target product content corresponding to the text.

Referring to FIG. 8, one or more embodiments provides an information processing apparatus. The apparatus includes:

a display module 801, configured to display a reading interface of a text reading platform, where the reading interface is configured for a reader to read an online or offline reading text; and

a presentation module 802, configured to present text of a target product content in the reading interface in response to receiving a page-turning event, where the text has a literary style feature associated with the reading text.

In a possible implementation, the presentation module 802 is configured to present the text and a prompt element in the reading interface, and the prompt element is configured for prompting that a text presented on a current page is the text. The prompt element includes at least one of a prompt text, a prompt icon, or a prompt page corner. The prompt page corner is located in a region where any page corner of the current page is located, and the prompt page corner is in a folded state.

In a possible implementation, the text includes an introductory text corresponding to the target product content, and the introductory text has a prominent presentation mark in a page where the text is presented.

In a possible implementation, the introductory text includes a time-sensitive text, and the time-sensitive text is configured for indicating a valid time of the target product content.

In a possible implementation, a presentation style of the text in the reading interface matches a presentation style of the reading text in the reading interface.

In a possible implementation, the presentation module 802 is further configured to present the target product content in the reading interface in response to that the presentation of the text meets a presentation requirement.

In a possible implementation, the presentation module 802 is configured to pop up an product content presentation slot in the page where the text is presented; and present the target product content in the product content presentation slot.

In a possible implementation, the presentation module 802 is configured to pop up the product content presentation slot in the page where the text is presented through an animation effect, where the animation effect matches the reading text.

In a possible implementation, the presentation module 802 is configured to present the target product content and historical interaction information corresponding to the target product content in the reading interface.

In a possible implementation, the target product content corresponds to different texts for different reading texts, and the different texts have different literary style features.

In a possible implementation, the text is generated by a natural language model based on a source material of the target product content and text feature information of the reading text.

In a possible implementation, the apparatus further includes:

an acquisition module, configured to acquire the source material of the target product content, the text feature information of the reading text, and a target text generation model; acquire input information of the target text generation model based on the source material and the text feature information; and invoke the target text generation model to perform text generation based on the input information to obtain the text.

In a possible implementation, the text includes a first text in a dialog form, and the associated literary style feature includes that a character in a dialog in the first text is associated with a character involved in content currently presented in the reading text.

The text feature information includes identification information of the character involved in the content currently presented and character relationship information of the reading text. The character relationship information is configured for indicating an association relationship among characters involved in the reading text, and the content currently presented is determined based on a target reading text page corresponding to the page-turning event.

In a possible implementation, the associated literary style feature further includes that a dialog tone of the character in the dialog in the first text matches a personality of the character described in the reading text.

The text feature information further includes character personality characterization content in the reading text. The character personality characterization content is configured for characterizing the personality of the character in the reading text. Character characterization content of any character includes at least one of dialog content of the any character in the reading text, an introduction of the any character provided by an author of the reading text, or description content of the any character in the reading text.

In a possible implementation, the text includes a first text in a dialog form, and the associated literary style feature includes that a dialog sentence structure of the first text matches a dialog sentence structure in the content currently presented in the reading text. The dialog sentence structure is configured for indicating a sequence of a character description and dialog content.

The text feature information includes a dialog text in the content currently presented. The dialog text is configured for characterizing the dialog sentence structure in the content currently presented, and the content currently presented is determined based on a target reading text page corresponding to the page-turning event.

In a possible implementation, the text includes a second text in a scene description form, and the associated literary style feature includes that a scene described in the second text is associated with a scene involved in the content currently presented in the reading text.

The text feature information includes a scene description text in the content currently presented. The scene description text is configured for characterizing the scene involved in the content currently presented, and the content currently presented is determined based on a target reading text page corresponding to the page-turning event.

In some embodiments, the content currently presented includes content of a last sentence in the target reading text page, content of a last paragraph in the target reading text page, entire content in the target reading text page, content of a chapter corresponding to the target reading text page, or entire content from a first sentence in the reading text to a last sentence in the target reading text page.

In some embodiments, the associated literary style feature includes that a language style type of the text is consistent with a language style type of the reading text; and the text feature information includes identification information of the language style type of the reading text.

In some embodiments, the associated literary style feature includes that a sentence pattern of the text is the same as a sentence pattern of the reading text; and the text feature information includes identification information of the sentence pattern of the reading text.

In some embodiments, the acquisition module is further configured to acquire object data of a reader; and acquire the input information based on the source material, the text feature information, and the object data.

In some embodiments, the target text generation model is obtained by training an initial text generation model based on a difference between a predicted text and a standard text. The predicted text is obtained by invoking the initial text generation model to perform text generation based on sample input information. The sample input information is determined based on a sample material of a sample product content and sample text feature information of a sample reading text. The standard text has a literary style feature associated with the sample reading text.

When the apparatus provided in the foregoing embodiments implements the functions of the apparatus, only division of the foregoing functional modules is used as an example for description. In the practical application, the functions may be allocated to and completed by different functional modules according to requirements. That is, an internal structure of a device is divided into different functional modules, to complete all or some of the functions described above. In addition, the apparatus and method embodiments provided in the foregoing embodiments belong to the same conception. For the specific implementation process, refer to the method embodiments in detail, and details are not described herein again. For effects achievable by the foregoing embodiments, refer to the method embodiments in detail, and details are not described herein again.

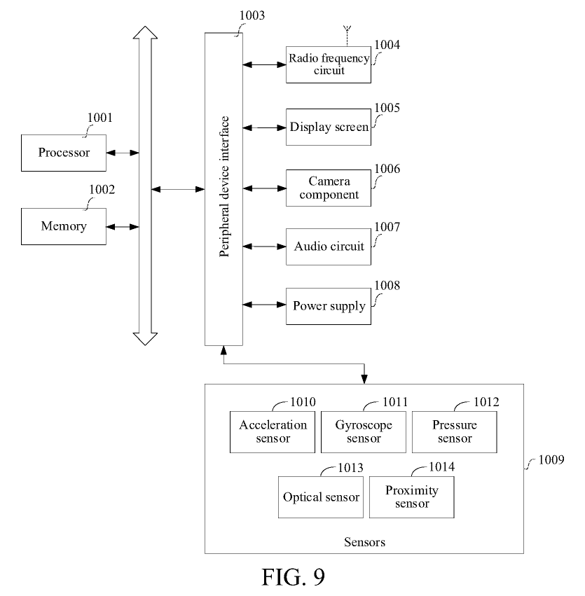

FIG. 9 is a schematic structural diagram of a computer device according to one or more embodiments. The computer device may be a terminal, for example, may be: a PC, a mobile phone, a smartphone, a PDA, a wearable device, a handheld portable game device, a PPC, a tablet computer, a smart vehicle machine, a smart television, a smart speaker, an on board terminal, and the like. The terminal may also be referred to as another name such as user equipment, a portable terminal, a laptop terminal, or a desktop terminal.

Generally, the terminal includes a processor 1001 and a memory 1002.

The processor 1001 may include one or more processing cores, such as a 4-core processor or an 8-core processor. In some embodiments, the processor 1001 may be integrated with a Graphics Processing Unit (GPU). The GPU is configured to render and draw content that needs to be displayed on a display screen. In some embodiments, the processor 1001 may further include an Artificial Intelligence (AI) processor. The AI processor is configured to process computing operations related to machine learning.

The memory 1002 may include one or more computer-readable storage media. The computer-readable storage medium may be non-transient. The memory 1002 may further include a high-speed random access memory and a non-volatile memory, for example, one or more disk storage devices or flash storage devices. In some embodiments, the non-transient computer-readable storage medium in the memory 1002 is configured to store at least one instruction. The at least one instruction is configured for being executed by the processor 1001 to cause the terminal to implement the information processing method provided in the method embodiments of the disclosure.

In some embodiments, the terminal may alternatively include: a peripheral device interface 1003 and at least one peripheral device.

The peripheral device interface 1003 may be configured to connect the at least one peripheral device related to Input/Output (I/O) to the processor 1001 and the memory 1002.

A radio frequency circuit 1004 is configured to receive and transmit a radio frequency (RF) signal, also referred to as an electromagnetic signal. The radio frequency circuit 1004 communicates with a communication network and other communication devices through the electromagnetic signal.

A display screen 1005 is configured to display a UI. The UI may include a graph, text, an icon, a video, and any combination thereof.

A camera component 1006 is configured to capture images or videos. In some embodiments, the camera component 1006 includes a front camera and a rear camera.

An audio circuit 1007 may include a microphone and a speaker.

A power supply 1008 is configured to supply power to components in the terminal.

In some embodiments, the terminal further includes one or more sensors 1009. The one or more sensors 1009 include, but are not limited to an acceleration sensor 1010, a gyroscope sensor 1011, a pressure sensor 1012, an optical sensor 1013, and a proximity sensor 1014.

A person skilled in the art may understand that the structure illustrated in FIG. 9 constitutes no limitation on the terminal, and the terminal may include more or fewer components than those illustrated therein, or some components may be combined, or a different component arrangement may be adopted.

In an exemplary embodiment, a computer device is further provided. The computer device includes a processor and a memory, and the memory has at least one computer program stored therein. The at least one computer program is loaded and executed by one or more processors, to cause the computer device to implement any one of the foregoing information processing methods.

In an exemplary embodiment, a computer-readable storage medium is further provided. The computer-readable storage medium has at least one computer program stored therein, and the at least one computer program is loaded and executed by a processor of a computer device to cause a computer to implement any one of the foregoing information processing methods.

A person of ordinary skill in the art may understand that all or some of the operations of the embodiments may be implemented by hardware or a program instructing relevant hardware. In some embodiments, the program is stored in the computer-readable storage medium. The computer-readable storage medium may be a Read-Only Memory (ROM), a Random Access Memory (RAM), a Compact Disc Read-Only Memory (CD-ROM), a magnetic tape, a floppy disk, an optical data storage device, or the like.

In an exemplary embodiment, a computer program or a computer program product is further provided. The computer program or the computer program product includes computer instructions, and the computer instructions are loaded and executed by a processor to cause a computer to implement any one of the foregoing information processing methods.

The information (including but not limited to user device information, user personal information, and the like), data (including but not limited to data for analysis, stored data, displayed data, and the like), and signals involved in the disclosure are all authorized by users or fully authorized by all parties, and the collection, use, and processing of relevant data comply with relevant laws, regulations and standards of relevant countries and regions. For example, object data of a reader involved in the disclosure is acquired with full authorization.

Terms such as "first" and "second" in the disclosure are used for distinguishing similar objects, and are not necessarily used for describing a specific order or sequence. Such used data is interchangeable where appropriate so that the embodiments described herein may be implemented in an order other than those illustrated or described herein. The implementations described in the above exemplary embodiments do not represent all implementations consistent with the disclosure. Rather, they are merely examples of apparatuses and methods consistent with some aspects of the disclosure.

"Multiple" mentioned herein refers to two or more. The term "and/or" describes the association relationship of associated objects, representing that there may be three relationships. For example, A and/or B may represent that A exists alone, A and B exist simultaneously, and B exists alone. The character "/" generally represents that associated objects are in an "or" relationship.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. An information processing method, being performed by a computer device and comprising:
displaying a reading interface of a text reading platform, the reading interface being configured for a reader to read an online or offline reading text; and
presenting text of target product content in the reading interface based on receiving a page-turning event, the text having a literary style feature associated with the reading text.

2. The information processing method according to claim 1, wherein presenting the text of the target product content in the reading interface comprises:
presenting the text and a prompt element in the reading interface, the prompt element being configured for prompting that the text be presented on a current page;
wherein the prompt element comprises at least one of a prompt text, a prompt icon, or a prompt page corner; the prompt page corner being located in a region where any page corner of the current page is located, and the prompt page corner being in a folded state.

3. The information processing method according to claim 1, wherein the text comprises an introductory text corresponding to the target product content, the introductory text having a prominent presentation mark in a page where the text is presented.

4. The information processing method according to claim 1, wherein a presentation style of the text in the reading interface matches a presentation style of the reading text in the reading interface.

5. The information processing method according to claim 1 wherein after presenting the text of the target product content in the reading interface, the method further comprises:
presenting the target product content in the reading interface based on the presentation of the text meeting a presentation requirement.

6. The information processing method according to claim 5, wherein presenting the target product content in the reading interface comprises:
popping up a content presentation slot in the page where the text is presented; and
presenting the target product content in the content presentation slot.

7. The information processing method according to claim 6, wherein popping up the content presentation slot in the page where the text is presented comprises:
popping up the content presentation slot in the page where the text is presented through an animation effect, the animation effect matching the reading text.

8. The information processing method according to claim 1, wherein the target product content corresponds to different texts for different reading texts, the different texts having different literary style features.

9. The information processing method according to claim 1, wherein the text is generated by a natural language model based on a source material of the target product content and text feature information of the reading text.

10. The information processing method according to claim 9, further comprising:
acquiring the source material of the target product content, the text feature information of the reading text, and a target text generation model;
acquiring input information of the target text generation model based on the source material and the text feature information; and
invoking the target text generation model to perform text generation based on the input information to obtain the text.

11. The information processing method according to claim 10, wherein the text comprises a first text in a dialog form, and an associated literary style feature comprises that a character in a dialog in the first text is associated with a character involved in content currently presented in the reading text; and
the text feature information comprises identification information of the character involved in the content currently presented and character relationship information of the reading text, the character relationship information being configured for indicating an association relationship among characters involved in the reading text, and the content currently presented being determined based on a target reading text page corresponding to the page-turning event.

12. The information processing method according to claim 11, wherein the associated literary style feature further comprises that a dialog tone of the character in the dialog in the first text matches a personality of the character described in the reading text; and
the text feature information further comprises a character personality characterization content in the reading text;
wherein the character personality characterization content is configured for characterizing a personality of a character in the reading text, and character characterization content of any character comprises at least one of dialog content of the any character in the reading text, an introduction of the any character provided by an author of the reading text, or description content of the any character in the reading text.

13. The information processing method according to claim 10, wherein the text comprises a first text in a dialog form, and an associated literary style feature comprises that a dialog sentence structure of the first text matches a dialog sentence structure in content currently presented in the reading text, the dialog sentence structure being configured for indicating a sequence of a character description and dialog content; and
the text feature information comprises a dialog text in the content currently presented, the dialog text being configured for characterizing the dialog sentence structure in the content currently presented, and the content currently presented being determined based on a target reading text page corresponding to the page-turning event.

14. The information processing method according to claim 10, wherein the text comprises a second text in a scene description form, and an associated literary style feature comprises that a scene described in the second text is associated with a scene involved in content currently presented in the reading text; and
the text feature information comprises a scene description text in the content currently presented, the scene description text being configured for characterizing the scene involved in the content currently presented, and the content currently presented being determined based on a target reading text page corresponding to the page-turning event.

15. The information processing method according to claim 11, wherein the content currently presented comprises content of a last sentence in the target reading text page, content of a last paragraph in the target reading text page, entire content in the target reading text page, content of a chapter corresponding to the target reading text page, or entire content from a first sentence in the reading text to the last sentence in the target reading text page.

16. The information processing method according to claim 10, wherein the associated literary style feature comprises that a language style type of the text is consistent with a language style type of the reading text; and
the text feature information comprises identification information of the language style type of the reading text.

17. The information processing method according to claim 10, wherein the associated literary style feature comprises that a sentence pattern of the text is the same as a sentence pattern of the reading text; and
the text feature information comprises identification information of the sentence pattern of the reading text.

18. The information processing method according to claim 10, further comprising: acquiring object data of the reader; and
wherein acquiring the input information based on the source material and the text feature information comprises:
acquiring the input information based on the source material, the text feature information, and the object data.

19. An information processing apparatus, comprising:
at least one memory configured to store program code; and
at least one processor configured to read the program code and operate as instructed by the program code, the program code comprising:
display code configured to cause at least one of the at least one processor to display a reading interface of a text reading platform, the reading interface being configured for a reader to read an online or offline reading text; and
presentation code configured to cause at least one of the at least one processor to present text of target product content in the reading interface based on receiving a page-turning event, the text having a literary style feature associated with the reading text.

20. A non-transitory computer-readable storage medium, storing computer code which, when executed by at least one processor, causes the at least one processor to at least:
display a reading interface of a text reading platform, the reading interface being configured for a reader to read an online or offline reading text; and
present text of target product content in the reading interface based on receiving a page-turning event, the text having a literary style feature associated with the reading text.
